(19) United States
(12) Patent Application Publication
(10) Pub. No.: US 2019/0070871 A1
(43) Pub. Date: Mar. 7, 2019

(54) IMAGE FORMING APPARATUS, PAPER PROCESSING SYSTEM AND COMPUTER READABLE STORAGE MEDIUM

(71) Applicant: KONICA MINOLTA, INC., Tokyo (JP)

(72) Inventors: Masahiro MATSUO, Tokyo (JP); Shingo SASAMI, Tokyo (JP); Ken MIYAZAKI, Sagamihara-shi (JP); Makoto UI, Tokyo (JP); Motoki NAKAMICHI, Tokyo (JP); Tomoo KUDO, Tokyo (JP)

(73) Assignee: KONICA MINOLTA, INC., Tokyo (JP)

(21) Appl. No.: 16/116,100

(22) Filed: Aug. 29, 2018

(30) Foreign Application Priority Data
Sep. 5, 2017 (JP) 2017-169954

(51) Int. Cl. B41J 13/00; B41J 15/04

(52) U.S. Cl. CPC B41J 13/0027; B65H 7/06; B41J 15/04

(57) ABSTRACT

An image forming apparatus is connected to a paper processing apparatus and includes an image forming unit, a nip part and a hardware processor. The image forming unit performs image forming on continuous paper being conveyed on a conveyance path. The nip part nips the paper on the conveyance path. The processor selectively performs first control and second control according to an output timing of a conveyance control signal if the signal is output from the paper processing apparatus or the image forming apparatus. In the first control, the processor notifies the paper processing apparatus of permission to start or stop conveying the paper after causing the nip part to perform a press-and-contact operation or a separation operation. In the second control, the processor notifies the paper processing apparatus of the permission without causing the nip part to perform either operation.

### BACKGROUND

### 1. Technological Field

The present invention relates to an image forming apparatus, a paper processing system and a computer readable storage medium.

### 2. Description of the Related Art

There is known an image forming system in which two or more apparatuses including an electrophotographic image forming apparatus are connected to one another and which performs predetermined processes on continuous paper, such as roll paper. (Refer to JP 2008-149657 A, JP 2015-221532 A and JP 2011-194569 A.)

In this type of image forming system, because the using paper is the continuous paper, if any of the apparatuses needs to stop conveying the continuous paper for replacement of a consumable(s) or the like, all of the apparatuses need to stop conveying the continuous paper.

However, conveyance distance which the continuous paper is conveyed until the conveyance is stopped after output of a stop signal and/or conveyance distance which the continuous paper is conveyed for restart of the operation differ from apparatus to apparatus, and also differ according to, for example, a state of each apparatus at the time of the output of the stop signal (during warming up, during image forming, etc.). Hence, if the same conveyance control is always performed, the continuous paper is, for example, pulled or slackens, and this causes poor paper conveyance, in particular, in a system in which two or more image forming apparatuses adopting different image forming methods are connected to one another.

### SUMMARY

The present invention has been conceived in view of the above problems, and objects of the present invention include preventing trouble caused by starts and/or stops of conveyance of continuous paper in a paper processing system in which two or more apparatuses including an image forming apparatus are connected to one another.

In order to achieve at least one of the abovementioned objects, according to an aspect of the present invention, there is provided an image forming apparatus that is connected to a paper processing apparatus and performs image forming on continuous paper being conveyed on a conveyance path, including: an image forming unit that performs the image forming on the continuous paper; a nip part that nips, on the conveyance path, the continuous paper; and a hardware processor that, according to an output timing of a conveyance control signal if the conveyance control signal is output from the paper processing apparatus or the image forming apparatus, selectively performs (i) first control in which the hardware processor notifies the paper processing apparatus of permission to start or stop conveying the continuous paper after causing the nip part to perform a press-and-contact operation or a separation operation and (ii) second control in which the hardware processor notifies the paper processing apparatus of the permission without causing the nip part to perform the press-and-contact operation or the separation operation.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention, wherein:

FIG. 1 shows an example of schematic configuration of a paper processing system of the present invention;

FIG. 2 is a functional block diagram showing control structure of the paper processing system; and

FIG. 3 is a flowchart showing a conveyance control process of the present invention.

### DETAILED DESCRIPTION OF EMBODIMENTS

Hereinafter, one or more embodiments of the present invention will be described in detail with reference to the drawings. However, the scope of the present invention is not limited to the disclosed embodiments or the drawings.

### [Configuration of Paper Processing System]

First, configuration of a paper processing system according to an embodiment(s) is described.

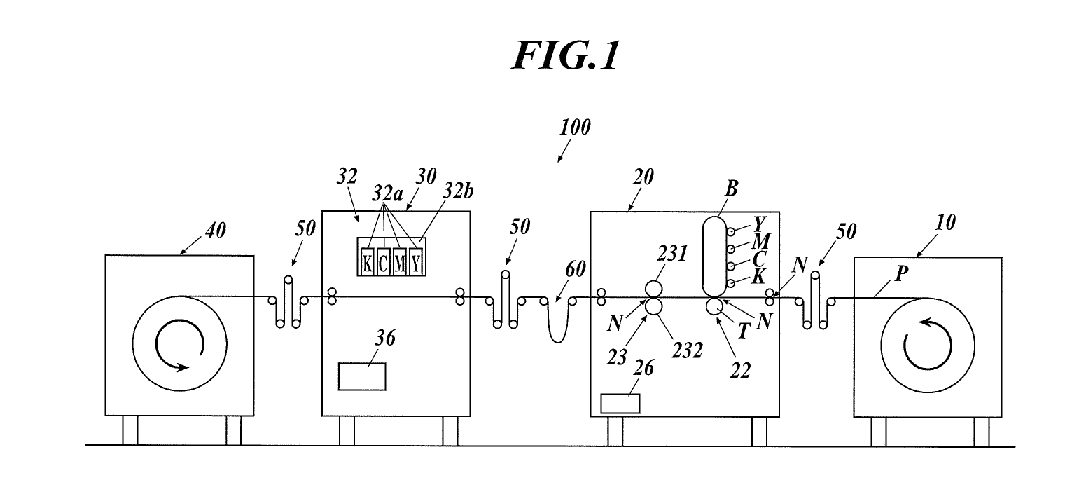

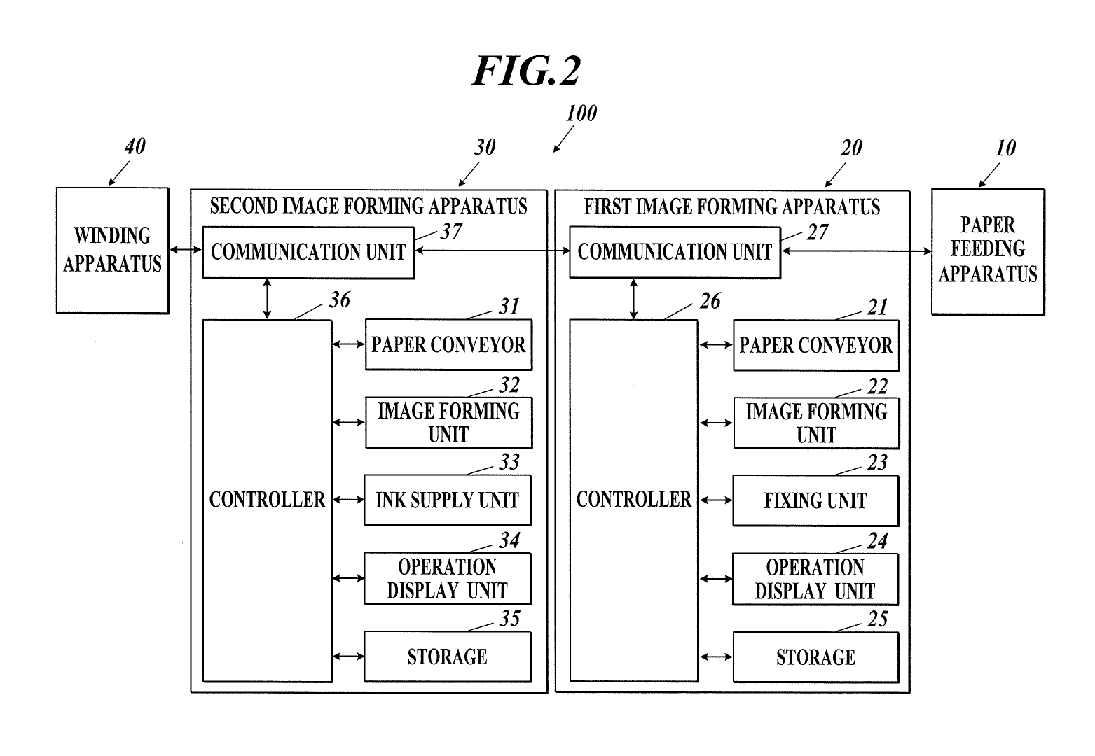

FIG. 1 shows an example of schematic configuration of a paper processing system 100. FIG. 2 is a functional block diagram showing control structure of the paper processing system 100.

The paper processing system 100 uses continuous paper (roll paper) P as a recording medium, and performs predetermined processes, such as image forming, on the continuous paper P.

As shown in FIG. 1, the paper processing system 100 is configured such that a paper feeding apparatus 10, a first image forming apparatus 20, a second image forming apparatus 30 and a winding apparatus 40 are arranged and connected in this order from the upstream side in a conveying direction of the continuous paper P.

The continuous paper P usable in this embodiment is not particularly limited in its material and so forth, and examples thereof include ordinary paper, paper made of resin as a main material, and converted paper generated by various processes performed on paper. Examples of the paper made of resin as a main material include synthetic paper made of polyethylene, polypropylene, polyethylene terephthalate or polyvinyl chloride, and YUPO® paper.

The paper feeding apparatus 10 is an apparatus that feeds the continuous paper P to the first image forming apparatus 20. In a casing of the paper feeding apparatus 10, for example, as shown in FIG. 1, the continuous paper P, which is roll paper, is wounded around and held by a support shaft to be rotatable. In the paper feeding apparatus 10, the continuous paper P wound around the support shaft is conveyed to the outside via a plurality of rollers (e.g. an unwinding roller, a paper feeding roller, etc.) at a constant speed. In the paper feeding apparatus 10, the continuous paper P does not need to be rolled to be held, and may be folded to be held. Further, although FIG. 1 shows only one continuous paper P, two or more continuous sheets each having a narrow width in a direction orthogonal to the conveying direction may be held side by side.

The first image forming apparatus 20 is an apparatus that forms images on the continuous paper P by electrophotography. The first image forming apparatus 20 is placed on the downstream side of the paper feeding apparatus 10 but on the upstream side of the second image forming apparatus 30 in the conveying direction of the continuous paper P.

The second image forming apparatus 30 is an apparatus that forms images on the continuous paper P by inkjet technology. The second image forming apparatus 30 is placed on the downstream side of the first image forming apparatus 20 but on the upstream side of the winding apparatus 40 in the conveying direction of the continuous paper P.

The winding apparatus 40 is an apparatus that winds up the continuous paper P conveyed from the second image forming apparatus 30. In a casing of the winding apparatus 40, for example, as shown in FIG. 1, the continuous paper P is wound around and rolled to be held by a support shaft. Hence, in the winding apparatus 40, the continuous paper P conveyed from the second image forming apparatus 30 is wound around the support shaft at a constant speed via a plurality of rollers (e.g. a paper receiving roller, a winding roller, etc.). In the winding apparatus 40, the continuous paper P does not need to be rolled to be held, and may be cut page by page (i.e. into sheets).

In the paper processing system 100, the first image forming apparatus 20 and the second image forming apparatus 30 are paper processing apparatuses that perform predetermined processes (first and second image forming processes in this embodiment) on the continuous paper P being conveyed on a conveyance path.

The first image forming apparatus 20 and the second image forming apparatus 30 have a controller 26 and a controller 36, respectively, and under control of the controller 26 and the controller 36, receive and send various types of information via a communication unit 27 and a communication unit 37, respectively.

Further, in the paper processing system 100, between the paper feeding apparatus 10 and the first image forming apparatus 20, and between the second image forming apparatus 30 and the winding apparatus 40, tension applying mechanisms 50 are arranged.

Still further, between the first image forming apparatus 20 and the second image forming apparatus 30, a buffer mechanism 60 (buffer part) and a tension applying mechanism 50 are arranged in this order from the upstream side in the conveying direction of the continuous paper P.

Each tension applying mechanism 50 includes dancer rollers, and applies a certain level of tension to the continuous paper P. The tension applying mechanism 50 may have any configuration as far as it can apply a certain level of tension to the continuous paper P.

The buffer mechanism 60 temporarily accumulates the continuous paper P.

More specifically, in order to absorb speed difference between conveyance speed of the continuous paper P of the first image forming apparatus 20 and conveyance speed of the continuous paper P of the second image forming apparatus 30, as shown in FIG. 1, the buffer mechanism 60 slackens and retains the continuous paper P, thereby adjusting (timing of) feeding of the continuous paper P to the second image forming apparatus 30. Further, the buffer mechanism 60 absorbs mutual pulling of the continuous paper P by and the slackness of the continuous paper P between the first image forming apparatus 20 and the second image forming apparatus 30 when conveyance of the continuous paper P is stopped, for example.

### <First Image Forming Apparatus>

Next, configuration of the first image forming apparatus 20 is described in detail.

The first image forming apparatus 20 is an electrophotographic image forming apparatus, such as a copier.

As shown in FIG. 2, the first image forming apparatus 20 includes a paper conveyor 21, an image forming unit 22, a fixing unit 23, an operation display unit 24, a storage 25, the controller 26 and the communication unit 27.

The paper conveyor 21 includes a conveyance path and a plurality of conveying units arranged on the conveyance path, and conveys the continuous paper P in the first image forming apparatus 20. More specifically, the paper conveyor 21 conveys the continuous paper P conveyed from the paper feeding apparatus 10 to the image forming unit 22, and conveys the continuous paper P having passed through the image forming unit 22 and the fixing unit 23 to the second image forming apparatus 30.

Each conveying unit is constituted of a pair of rollers that press and contact one another and form a nip part (conveyance nip part) N, and at least one of the rollers is rotationally driven through a drive mechanism that includes an electric motor as a main component, thereby conveying the continuous paper P. Each pair of rollers constituting each conveying unit is configured to switch its inter-roller state between a press-and-contact state and a separate state.

The image forming unit 22 forms toner images by electrophotography, and transfers the toner images to the continuous paper P.

For example, in the image forming unit 22, photoconductive drums (Y, M, C, K) and an intermediate transfer belt B are arranged (shown in FIG. 1). The intermediate transfer belt B is an endless belt, and wound around and supported by a plurality of rollers to be runnable. Toner images of the respective colors formed on the photoconductive drums (Y, M, C, K) are successively transferred onto the intermediate transfer belt B so as to form, on the intermediate transfer belt B, a toner image (a color image) constituted of layers of the respective colors (Y, M, C, K) superposed on top of one another. Then, a bias having a polarity reversed from that of the toners is applied to a transfer roller T that forms a nip part (transfer nip part) N by being arranged to press and contact the intermediate transfer belt B, so that the toner image formed on the intermediate transfer belt B is transferred onto the continuous paper P. The transfer roller T is configured to switch its state with the intermediate transfer belt B between the press-and-contact state and the separate state.

The fixing unit 23 fixes the toner image transferred onto the continuous paper P.

For example, the fixing unit 23 includes a pair of rollers constituted of a heating roller 231 and a pressurizing roller 232 (shown in FIG. 1) to nip the continuous paper P (i.e. hold the continuous paper P between the rollers).

The heating roller 231 is heated to a predetermined temperature by a heater as a heat source.

The pressurizing roller 232 is biased to the heating roller 231 by a not-shown elastic member. The continuous paper P onto which the toner image has been transferred is given heat and pressure by passing through a nip part (fixing nip part) N constituted of the heating roller 231 and the pressuring roller 232, so that the toner image is fused to the continuous paper P. The heating roller 231 and the pressurizing roller 232 are configured to switch their inter-roller state between the press-and-contact state and the separate state.

Near the outer circumferential surface of the pressurizing roller 232, a temperature sensor (not shown) is arranged to measure temperature near the outer circumferential surface of the pressurizing roller 232 as temperature of the fixing unit 23.

The operation display unit 24 includes a display screen, a display that displays various types of information on the display screen, and an operation section that is used by a user to input various instructions.

The storage 25 is constituted of an HDD (Hard Disk Drive), a nonvolatile semiconductor memory and/or the like.

The storage 25 stores various programs including system programs and process programs that are executed by the controller 26, data necessary for execution of these programs, and so forth. For example, the storage 25 stores various types of setting information necessary to perform the first image forming process and a conveyance control process(es). Further, the storage 25 temporarily stores image data on images to be formed on the continuous paper P.

The controller 26 controls operations of the components of the first image forming apparatus 20, thereby controlling the whole operation.

The controller 26 includes a CPU (Central Processing Unit, hardware processor) and a RAM (Random Access Memory). The CPU of the controller 26 reads the various programs, such as the system programs and the process programs, stored in the storage 25, to load the read programs to the RAM, and performs various processes in accordance with the loaded programs.

For example, the controller 26 controls the components of the first image forming apparatus 20 to perform a process for forming images on the continuous paper P (first image forming process).

Further, the controller 26 performs the conveyance control process of, when a conveyance stop signal (conveyance control signal) is output from any of the apparatuses constituting the paper processing system 100, selecting one of first control and second control according to the output timing of the conveyance stop signal, thereby controlling conveyance of the continuous paper P. This conveyance control process is described below in detail.

The communication unit 27 includes a serial communication interface, and performs communications with the second image forming apparatus 30, the paper feeding apparatus 10 and the winding apparatus 40 to send and receive information on various processes and so forth.

The first image forming apparatus 20 may be an MFP (Multi-Function Peripheral) having a copier function, a scanner function, a facsimile function and so forth as well as an image forming function.

### <Second Image Forming Apparatus>

Next, configuration of the second image forming apparatus 30 is described in detail.

In this embodiment, the second image forming apparatus 30 is an inkjet image forming apparatus, such as an inkjet recording apparatus.

As shown in FIG. 2, the second image forming apparatus 30 includes a paper conveyor 31, an image forming unit 32, an ink supply unit 33, an operation display unit 34, a storage 35, the controller 36 and the communication unit 37.

The paper conveyor 31 includes a conveyance path and a plurality of conveying units arranged on the conveyance path, and conveys the continuous paper P in the second image forming apparatus 30. More specifically, the paper conveyor 31 conveys the continuous paper P conveyed from the first image forming apparatus 20 to the image forming unit 32, and conveys the continuous paper P having passed through the image forming unit 32 to the winding apparatus 40.

Each conveying unit is constituted of a pair of rollers that press and contact one another and form a nip part, and at least one of the rollers is rotationally driven through a drive mechanism that includes an electric motor as a main component, thereby conveying the continuous paper P. Each pair of rollers constituting each conveying unit is configured to switch its inter-roller state between a press-and-contact state and a separate state.

The image forming unit 32 forms images on the continuous paper P by discharging (ejecting) ink droplets from nozzles of inkjet heads.

The image forming unit 32 includes a plurality of line heads 32a and a carriage 32b that holds the line heads 32a.

The line heads 32a discharge inks to the continuous paper P being conveyed by the paper conveyor 31. The line heads 32a are provided for respective colors of Y (yellow), M (magenta), C (cyan) and K (black). In FIG. 1, the line heads 32a for the colors of Y, M, C, K are arranged in this order from the upstream side in the conveying direction of the continuous paper P.

The line heads 32a are arranged in the carriage 32b. Each line head 32a has a length (width) that covers the whole continuous paper P in a direction (width direction) approximately perpendicular to the conveying direction of the continuous paper P. That is, the second image forming apparatus 30 is a single-pass line-head inkjet recording apparatus. Each line head 32a is constituted of a plurality of inkjet heads arranged. The carriage 32b may be provided with a carriage heater (not shown) to heat the inks.

If energy-ray curable ink is used as the inks, it is preferable to provide an emitter that emits energy rays to cure the inks after the inks are discharged onto the continuous paper P.

The emitter is arranged on the downstream side of the line heads 32a in the conveying direction of the continuous paper P, and emits energy rays to the continuous paper P on which an image(s) has been formed, thereby curing the inks discharged onto the continuous paper P.

The ink supply unit 33 stores the inks and supplies the inks to their respective line heads 32a of the image forming unit 32 so that the inks of the respective colors can be discharged from the nozzles of the line heads 32a.

Ink usable in this embodiment is not particularly limited. Examples of the ink include the energy-ray (ultraviolet) curable ink, and ink made of inorganic and organic pigments dispersed in an organic solvent.

The operation display unit 34 includes a display screen, a display that displays various types of information on the display screen, and an operation section that is used by a user to input various instructions.

The storage 35 is constituted of an HDD, a nonvolatile semiconductor memory and/or the like.

The storage 35 stores various programs including system programs and process programs that are executed by the controller 36, data necessary for execution of these programs, and so forth. For example, the storage 35 stores various types of setting information necessary to perform the second image forming process.

The controller 36 controls operations of the components of the second image forming apparatus 30, thereby controlling the whole operation.

The controller 36 includes a CPU and a RAM. The CPU of the controller 36 reads the various programs, such as the system programs and the process programs, stored in the storage 35, to load the read programs to the RAM, and performs various processes in accordance with the loaded programs.

For example, the controller 36 controls the components of the second image forming apparatus 30 to perform a process for forming images on the continuous paper P (second image forming process).

Further, the controller 36 controls conveyance of the continuous paper P in response to a permission notice sent from the first image forming apparatus 20 that is in execution of the conveyance control process.

The communication unit 37 includes a serial communication interface, and performs communications with the paper feeding apparatus 10, the first image forming apparatus 20 and the winding apparatus 40 to send and receive information on various processes and so forth.

In the above, the inkjet recording apparatus (second image forming apparatus 30) uses the line heads 32a, but is not limited thereto. For example, the inkjet recording apparatus may be a scanning inkjet recording apparatus that forms images by inkjet heads performing scans in a direction orthogonal to the conveying direction of the continuous paper P.

Further, in the above, the inkjet recording apparatus is configured to use the inks of Y (yellow), M (magenta), C (cyan) and K (black), but is not limited thereto. For example, the inkjet recording apparatus may be configured to use ink of one color, for example, ink of K (black) only.

Still further, the color of ink to be used is not particularly limited, and hence, other than the above, may be clear (transparent), gold, silver and/or the like, which are called spot color or special color.

### [Operation of Paper Processing System]

Next, operation of the paper processing system 100, the first image forming apparatus 20 in particular, is described.

The first image forming apparatus 20 of this embodiment performs the below-described conveyance control process if a conveyance stop signal is output from any of the apparatuses constituting the paper processing system 100 while the first image forming apparatus 20 is in operation. In the conveyance control process, the first image forming apparatus 20 selects one of the first control and the second control according to the output timing (received timing) of a conveyance stop signal, thereby controlling (stopping) conveyance of the continuous paper P.

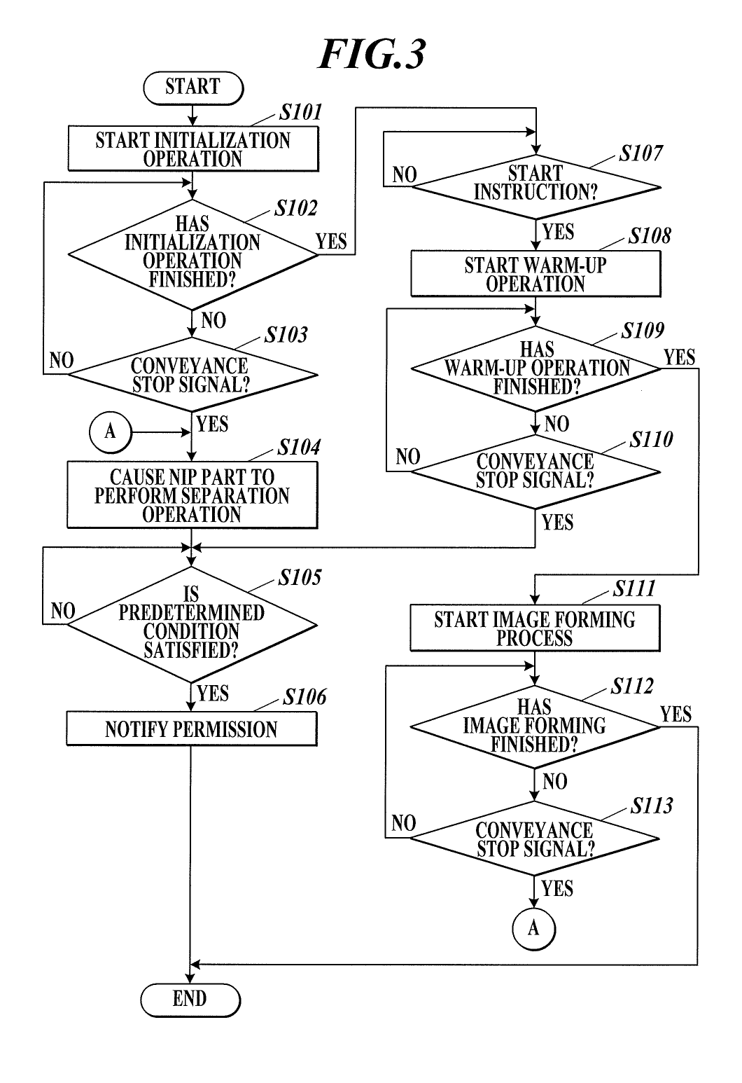

FIG. 3 is a flowchart showing the conveyance control process.

First, when the first image forming apparatus 20 is turned on, the controller 26 starts initialization operation (Step S101).

More specifically, when the first image forming apparatus 20 is turned on, the controller 26 notifies the second image forming apparatus 30 of prohibition on conveyance of the continuous paper P, and checks operation of each pair of rollers or the like in the first image forming apparatus 20 by causing the rollers or the like to separate from one another (separation operation) and to press and contact one another (press-and-contact operation) as the initialization operation.

Next, the controller 26 determines whether or not the initialization operation has finished (Step S102). When determining that the initialization operation has not finished yet (Step S102: NO), the controller 26 determines whether or not a conveyance stop signal has been output (received) from the first image forming apparatus 20 or the second image forming apparatus 30 (Step S103).

When determining that no conveyance stop signal has been output (Step S103: NO), the controller 26 returns to and repeats Step S102 and the following step(s).

On the other hand, when determining that a conveyance stop signal has been output (Step S103: YES), the controller 26 causes the nip parts (the conveyance nip parts, the transfer nip part, the fixing nip part, etc.) N to perform the separation operation (Step S104).

In Step S104, it is preferable that the controller 26 determine whether or not image data on a non-output/non-formed image(s), which has not been output/formed yet, is stored in the storage 25, and when determining that image data on a non-output/non-formed image(s) is stored, the controller 26 causes the nip parts N to perform the separation operation after an image(s) based on the image data is formed.

That is, if image data is stored in the storage 25 at the time when a conveyance stop signal is output, the controller 26 causes the nip parts N to perform the separation operation after an image(s) based on the image data is formed.

Next, the controller 26 determines whether or not a predetermined/preset condition to permit a stop of conveyance of the continuous paper P is satisfied (Step S105).

The predetermined condition is a condition set for stopping conveyance of the continuous paper P after inside of the first image forming apparatus 20 becomes an appropriate environment. For example, the predetermined condition includes at least one of (i) a condition that elapsed time since output of a conveyance stop signal is equal to or larger (longer) than a set value and (ii) a condition that temperature(s) at the nip part(s) N is equal to or smaller (lower) than a set value.

The set values for the elapsed time and the temperature at the nip parts N can be changed appropriately. For example, the set values for the elapse time and/or the temperature at the nip parts N may be changed according to the type of the continuous paper P. For example, if the continuous paper P is made of material having a preset level of heat resistance, the set value for the elapsed time may be small (short), and the set value for the temperature at the nip parts N may be large (high). Further, the set values for the elapsed time and the temperature at the nip parts N may be changed according to environment, such as temperature and/or humidity, around the first image forming apparatus 20.

In this way, conveyance of the continuous paper P is stopped after the inside of the first image forming apparatus 20 becomes an appropriate environment. This can prevent trouble, for example, prevent the continuous paper P from being damaged by influence of accumulated heat or the like after conveyance of the continuous paper P is stopped.

When determining that the predetermined condition is not satisfied (Step S105: NO), the controller 26 repeats Step S105.

In this way, the continuous paper P keeps being conveyed without a stop until the predetermined condition is satisfied.

Examples of how to keep conveying the continuous paper P include: conveying the continuous paper P in one direction of the conveying direction of the continuous paper P, namely, from the upstream side to the downstream side; and conveying the continuous paper P in both directions of the conveying direction of the continuous paper P alternately from the upstream side to the downstream side and from the downstream side to the upstream side, namely, reciprocating the continuous paper P, every predetermined period of time, which can prevent wasteful blank parts from being generated on the continuous paper P.

Next, the controller 26 notifies the second image forming apparatus 30 of permission (or instruction if a conveyance stop signal is output from the first image forming apparatus 20) to stop conveying the continuous paper P (i.e. sends a permission notice to the second image forming apparatus 30) (Step S106), and finishes the conveyance control process.

In this way, if a conveyance stop signal is output during the initialization operation, the permission notice is sent after the nip parts N perform the separation operation (first control).

In the second image forming apparatus 30, when receiving the permission notice, the controller 36 performs control to stop conveyance of the continuous paper P.

In Step S102, when determining that the initialization operation has finished (Step S102: YES), the controller 26 determines whether or not an instruction to start image forming (image forming start instruction) has been received (Step S107). When determining that an image forming start instruction has been received (Step S107: YES), the controller 26 starts warm-up operation (Step S108).

More specifically, when the initialization operation finishes, the controller 26 notifies the second image forming apparatus 30 of permission to start conveying the continuous paper P, and starts the warm-up operation when receiving, as the image forming start instruction, an image forming start instruction signal from an external apparatus, an image forming start instruction signal based on a user operation on the operation display unit 24, or the like.

As the warm-up operation, conveyance of the continuous paper P near the fixing unit 23 is started, and the heater of the fixing unit 23 is turned on, for example.

Next, the controller 26 determines whether or not the warm-up operation has finished (Step S109). When determining that the warm-up operation has not finished yet (Step S109: NO), the controller 26 determines whether or not a conveyance stop signal has been output from the first image forming apparatus 20 or the second image forming apparatus 30 (Step S110).

When determining that no conveyance stop signal has been output (Step S110: NO), the controller 26 returns to and repeats Step S109 and the following step(s).

On the other hand, when determining that a conveyance stop signal has been output (Step S110: YES), the controller 26 proceeds to Step S105.

In this way, if a conveyance stop signal is output during the warm-up operation, the permission notice is sent immediately without the separation operation of the nip parts N (second control).

In Step S109, when determining that the warm-up operation has finished (Step S109: YES), the controller 26 starts the first image forming process (Step S111).

More specifically, when the warm-up operation finishes, the controller 26 notifies the second image forming apparatus 30 of the conveyance speed of the continuous paper P during image forming, and then starts preparation for image forming. The preparation includes: operating an image forming system (e.g. the image forming unit 22); and causing the nip parts N to perform the press-and-contact operation. After finishing the preparation for image forming, the controller 26 notifies the second image forming apparatus 30 of the fact that the preparation for image forming has finished, and causes the image forming unit 22 to start image writing, which is included in the image forming.

Next, the controller 26 determines whether or not the image forming has finished (Step S112). When determining that the image forming has finished (Step S112: YES), the controller 26 finishes the conveyance control process.

On the other hand, when determining that the image forming has not finished yet (Step S112: NO), the controller 26 determines whether or not a conveyance stop signal has been output from the first image forming apparatus 20 or the second image forming apparatus 30 (Step S113).

When determining that no conveyance stop signal has been output (Step S113: NO), the controller 26 returns to and repeats Step S112 and the following step(s).

On the other hand, when determining that a conveyance stop signal has been output (Step S113: YES), the controller 26 proceeds to Step S104.

In this way, if a conveyance stop signal is output during the image forming, the permission notice is sent after the nip parts (the conveyance nip parts, the transfer nip part, the fixing nip part, etc.) N perform the separation operation (first control).

In order to reduce damage to the continuous paper P, the flowchart shown in FIG. 3 contains Step S105, in which the controller 26 determines whether or not the predetermined condition is satisfied. This step may be omitted in terms of productivity.

Further, in Step S104, if image data on a non-output/non-formed image(s) is stored in the storage 25 at the time when a conveyance stop signal is output, the controller 26 causes the nip parts N to perform the separation operation after an image(s) based on the image data is formed. The controller 26 may, however, cause the nip parts N to perform the separation operation, regardless of whether or not image data on a non-output/non-formed image(s), which has not been output/formed yet, is present.

As described above, according to this embodiment, the first image forming apparatus 20 is connected to the second image forming apparatus 30, and performs image forming on the continuous paper P being conveyed on the conveyance path. The first image forming apparatus 20 includes the image forming unit 22, the nip part(s) N and the controller 26. The image forming unit 22 performs the image forming on the continuous paper P. The nip part(s) N nips, on the conveyance path, the continuous paper P. If a conveyance stop signal (conveyance control signal) is output from the second image forming apparatus 30 or the first image forming apparatus 20, according to the output timing of the conveyance stop signal, the controller 26 selectively performs (i) the first control in which the controller 26 notifies the second image forming apparatus 30 of the permission to stop conveying the continuous paper P after causing the nip part(s) N to perform the separation operation and (ii) the second control in which the controller 26 notifies the second image forming apparatus 30 of the permission without causing the nip part(s) N to perform the separation operation.

This can prevent poor paper conveyance caused by the mutual pulling, the slackness or the like of the continuous paper P at the time when conveyance of the continuous paper P is stopped.

That is, this can prevent trouble due to stops of conveyance of the continuous paper P in the paper processing system 100 in which two or more apparatuses are connected to one another.

Further, according to this embodiment, the controller 26 performs the first control if the conveyance stop signal is output during the initialization operation of the first image forming apparatus 20 or during the image forming by the image forming unit 22.

In this way, during the initialization operation of the first image forming apparatus 20 or the image forming by the image forming unit 22, the controller 26 permits the second image forming apparatus 30 to stop conveying the continuous paper P after causing the rollers or the like constituting each nip part N to separate from one another. This can prevent poor paper conveyance caused by influence of the rollers or the like, which constitute each nip part N, pressing and contacting one another.

Further, according to this embodiment, the controller 26 performs the second control if the conveyance stop signal is output during the warm-up operation of the first image forming apparatus 20.

In this way, if the conveyance stop signal is output during the warm-up operation of the first image forming apparatus 20, the controller 26 permits the second image forming apparatus 30 to stop conveying the continuous paper P immediately. This is because the rollers or the like, which constitutes each nip part N, pressing and contacting one another do not affect paper conveyance. The above can stop conveyance of the continuous paper P promptly.

Other than during the warm-up operation of the first image forming apparatus 20, the controller 26 selects the second control if the first image forming apparatus 20 is in a state in which the rollers or the like, which constitute each nip part N, pressing and contacting one another do not affect paper conveyance. For example, the controller 26 selects the second control if the continuous paper P is being conveyed by/in the second image forming apparatus 30.

Further, according to this embodiment, the first image forming apparatus 20 includes the storage 25 that temporarily stores image data, and if image data is stored in the storage 25 at the output timing of the conveyance stop signal, in the first control, the controller 26 causes the nip part(s) N to perform the separation operation after the image forming unit 22 performs the image forming based on the image data.

In this way, conveyance of the continuous paper P is stopped after all images, which have been scheduled by the time of the output of the conveyance stop signal to be formed, are formed on the basis of the image data.

Further, according to this embodiment, in the first control and the second control, before notifying the second image forming apparatus 30 of the permission, the controller 26 determines whether or not a predetermined condition is satisfied, and if the controller 26 determines that the predetermined condition is satisfied, notifies the second image forming apparatus 30 of the permission.

The predetermined condition includes at least one of (i) a condition that elapsed time since the output timing of the conveyance stop signal is equal to or larger than a set value and (ii) a condition that temperature at the nip part(s) N is equal to or smaller than a set value.

In this way, conveyance of the continuous paper P is stopped after the inside of the first image forming apparatus 20 becomes an appropriate environment. This can prevent, for example, the continuous paper P from being damaged by influence of accumulated heat or the like after conveyance of the continuous paper P is stopped.

Further, according to this embodiment, the image forming unit 22 performs the image forming by electrophotography.

This can prevent trouble due to stops of conveyance of the continuous paper P in the paper processing system 100 which includes the first image forming apparatus 20 that forms images by electrophotography.

In the above embodiment, the conveyance control process to stop conveyance of the continuous paper P is performed in response to a conveyance stop signal. The conveyance control signal, however, includes a conveyance start signal to start conveyance of the continuous paper P. If a conveyance start signal is output as the conveyance control signal, the controller 26 performs, in response to the conveyance start signal, a conveyance control process to start conveyance of the continuous paper P.

More specifically, if a conveyance start signal is output, according to the output timing of the conveyance start signal, the controller 26 selectively performs (i) first control in which the controller 26 notifies the second image forming apparatus 30 of permission to start conveying the continuous paper P after causing the nip part(s) N to perform the press-and-contact operation and (ii) second control in which the controller 26 notifies the second image forming apparatus 30 of the permission without causing the nip part(s) N to perform the press-and-contact operation.

This can prevent trouble due to starts of conveyance of the continuous paper P in the paper processing system 100 in which two or more apparatuses are connected to one another.

Further, the controller 26 performs the first control if the conveyance start signal is output, for example, during the initialization operation, and performs the second control if the conveyance start signal is output, for example, during the warm-up operation.

Further, in the above embodiment, the second image forming apparatus 30 is an inkjet recording apparatus, but may be an electrophotographic image forming apparatus like the first image forming apparatus 20.

The second image forming apparatus 30 may be an apparatus that forms a predetermined pattern(s) made of varnish, leaf/foil or the like on the continuous paper P, or may be an apparatus that performs, on the continuous paper P, a process(es) in addition to or instead of image forming, for example, a post-processing apparatus that performs slitting, die-cutting and/or the like.

Such an apparatus may be arranged on the upstream side of the first image forming apparatus 20 in the conveying direction of the continuous paper P, if appropriate.

Further, in the above embodiment, the paper processing system 100 has two paper processing apparatuses (the first image forming apparatus 20 and the second image forming apparatus 30) connected to one another. The number of the paper processing apparatuses to be connected to one another is, however, not limited to two.

Further, in the above embodiment, as shown in FIG. 2, the paper processing system 100 is configured such that the paper processing apparatuses have their respective controllers, and each controller controls its apparatus in response to information (e.g. the permission notice) from another apparatus, but may be configured to have a central controller that controls operation of the paper processing system 100 in whole.

In this case, the central controller outputs commands to perform processes to the controllers (the controller 26 and the controller 36) of the paper processing apparatuses connected to one another, and the controllers control, in response to the commands, operations of their respective apparatuses, which are their respective control targets.

Alternatively, one of the controllers of the paper processing apparatuses may serve as the central controller.

Further, in the paper processing system 100, if a conveyance stop signal due to occurrence of abnormality that puts a user in danger or breaks down the apparatus(es) is output, conveyance of the continuous paper P is stopped immediately, regardless of its output timing.

Although one or more embodiments of the present invention have been described and illustrated in detail, the disclosed embodiment(s) are made for purposes of illustration and example only and not limitation. The scope of the present invention should be interpreted by terms of the appended claims.

The entire disclosure of Japanese Patent Application No. 2017-169954 filed on Sep. 5, 2017 is incorporated herein by reference in its entirety.

What is claimed is:

1. An image forming apparatus that is connected to a paper processing apparatus and performs image forming on continuous paper being conveyed on a conveyance path, comprising:
an image forming unit that performs the image forming on the continuous paper;
a nip part that nips, on the conveyance path, the continuous paper; and
a hardware processor that, according to an output timing of a conveyance control signal if the conveyance control signal is output from the paper processing apparatus or the image forming apparatus, selectively performs (i) first control in which the hardware processor notifies the paper processing apparatus of permission to start or stop conveying the continuous paper after causing the nip part to perform a press-and-contact operation or a separation operation and (ii) second control in which the hardware processor notifies the paper processing apparatus of the permission without causing the nip part to perform the press-and-contact operation or the separation operation.

2. The image forming apparatus according to claim 1, wherein the hardware processor performs the first control if the conveyance control signal is output during an initialization operation of the image forming apparatus or during the image forming by the image forming unit.

3. The image forming apparatus according to claim 1, wherein the hardware processor performs the second control if the conveyance control signal is output during an warm-up operation of the image forming apparatus.

4. The image forming apparatus according to claim 1, comprising a storage that temporarily stores image data, wherein
if the image data is stored in the storage at the output timing of the conveyance control signal, in the first control, the hardware processor causes the nip part to perform the separation operation after the image forming unit performs the image forming based on the image data.

5. The image forming apparatus according to claim 1, wherein in the first control and the second control, before notifying the paper processing apparatus of the permission, the hardware processor determines whether or not a predetermined condition is satisfied, and if the hardware processor determines that the predetermined condition is satisfied, notifies the paper processing apparatus of the permission.

6. The image forming apparatus according to claim 5, wherein the predetermined condition includes at least one of (i) a condition that elapsed time since the output timing of the conveyance control signal is equal to or larger than a set value and (ii) a condition that a temperature at the nip part is equal to or smaller than a set value.

7. The image forming apparatus according to claim 1, wherein the image forming unit performs the image forming by electrophotography.

8. A paper processing system that performs a predetermined process on continuous paper being conveyed on a conveyance path, comprising:
a plurality of paper processing apparatuses connected to one another, wherein
at least one of the paper processing apparatuses is the image forming apparatus according to claim 1.

9. The paper processing system according to claim 8, comprising a buffer part between the paper processing apparatuses, the buffer part temporarily accumulating the continuous paper.

10. A non-transitory computer readable storage medium storing a program causing a computer of an image forming apparatus connected to a paper processing apparatus, the image forming apparatus including an image forming unit that performs image forming on continuous paper being conveyed on a conveyance path, and a nip part that nips, on the conveyance path, the continuous paper, to perform:
according to an output timing of a conveyance control signal if the conveyance control signal is output from the paper processing apparatus or the image forming apparatus, selectively performing (i) first control in which the computer notifies the paper processing apparatus of permission to start or stop conveying the continuous paper after causing the nip part to perform a press-and-contact operation or a separation operation and (ii) second control in which the computer notifies the paper processing apparatus of the permission without causing the nip part to perform the press-and-contact operation or the separation operation.
